(19) United States
(12) Patent Application Publication
(10) Pub. No.: US 2025/0210833 A1
(43) Pub. Date: Jun. 26, 2025

(54) METHOD OF PRODUCING SECONDARY BATTERY, AND SECONDARY BATTERY

(71) Applicant: TOYOTA JIDOSHA KABUSHIKI KAISHA, Toyota-shi Aichi-ken (JP)

(72) Inventor: Toshinori OKURA, Toyota-shi Aichi-ken (JP)

(73) Assignee: TOYOTA JIDOSHA KABUSHIKI KAISHA, Toyota-shi Aichi-ken (JP)

(21) Appl. No.: 18/960,544

(22) Filed: Nov. 26, 2024

(30) Foreign Application Priority Data
Dec. 21, 2023 (JP) 2023-215801

(51) Int. Cl. H01M 50/636

(52) U.S. Cl. CPC H01M 50/636

(57) ABSTRACT

Production of an insufficiently sealed product is suppressed by sealing by welding a sealing material to a filling port of a secondary battery. A transparent resin film is used as the sealing material.

### CROSS-REFERENCE TO RELATED APPLICATIONS

This application is based upon and claims the benefit of priority of the prior Japanese Patent Application No. 2023-215801, filed on Dec. 21, 2023, the entire contents of which are incorporated herein by reference.

### TECHNICAL FIELD

The present disclosure relates to a method of producing a secondary battery, and a secondary battery.

### BACKGROUND

The production of lithium ion batteries includes the step of injecting an electrolytic solution via a filling port provided at the battery, and thereafter, sealing the filling port by welding using a sealing material.

Patent literature 1 discloses that a bipolar-type lithium ion battery is sealed in a state where a plurality of adjacent cells are in one filling frame. Here, in conventional arts including patent literature 1, sheets formed by laminating aluminum foil with resin (aluminum laminated sheets) are conventionally used for lithium ion batteries in view of resistance to electrolytic solutions.

### CITATION LIST

### Patent Literature

Patent Literature 1: JP 2019-175778 A

### SUMMARY

### Technical Problem

It is important to certainly perform the sealing. Insufficient sealing due to air bubbles (voids) etc. sealing face (welded part) may cause electrolytic solutions in different cells to be mixed. This may lead to short circuits, which can cause heat generation and/or ignition.

Objects of the present disclosure are: to provide a method of producing a secondary battery by sealing by welding a sealing material to a filling port of the battery, thereby being capable of suppressing production of an insufficiently sealed product; and to provide such a secondary battery.

### Solution to Problem

The sealing is performed by welding as described above in view of cost reduction. However, because air bubbles caused by welding are generated suddenly, inspection is necessary every time. For this, the inventor thought up an idea that production of insufficiently sealed products can be suppressed by making it easier to carry out inspection, and realized this idea.

The present application discloses a method of producing a secondary battery that has an electrode, the method comprising: filling the electrode with an electrolytic solution via a filling port surrounded by a tubular member; welding a transparent resin film to the tubular member, and sealing an opening of the tubular member; and inspecting a welded condition of the tubular member and the resin film, and detecting presence or not of an unwelded area by a method by visual observation, or by a method of identifying a nonjoint portion by processing an image obtained by photographing the resin film welded to the tubular member.

The “tubular member” surrounding the filling port may be simply referred to as a “filling frame”.

The tubular member may contain polyethylene, and the resin film may have a polyethylene layer.

The resin film may have a polyvinyl alcohol layer, and the polyethylene layer may be side of the tubular member.

In the welding and sealing, the resin film may be welded to the tubular member by pressing a heating body against the resin film.

In the welding and sealing, the welding may be performed by irradiation with a laser from a side of the resin film along the tubular member after the resin film is brought into contact with the tubular member, the laser having a wavelength that the tubular member and the resin film can absorb.

In the inspecting and detecting, the detecting may be performed by irradiating a welded face of the tubular member to the resin film with a polarized light, and receiving a reflected light of the polarized light.

The present application discloses a secondary battery comprising: a filling port for injecting an electrolytic solution into an electrode; a tubular member formed so as to surround the filling port; and a transparent resin film covering an opening of the tubular member.

In the secondary battery, the tubular member may contain polyethylene, and the resin film may have a polyethylene layer.

In the secondary battery, the resin film may have a polyvinyl alcohol layer, and the polyethylene layer may be side of the tubular member.

### Effects

According to the present disclosure, the presence or not of faults in joining of a tubular member with a film for sealing, such as voids, can be easily inspected, and production of insufficiently sealed secondary batteries as products can be suppressed.

### BRIEF DESCRIPTION OF DRAWINGS

FIG. 1 is a schematic external view illustrating a secondary battery 10;

FIG. 2 illustrates an internal structure of an electricity storage module 12;

FIG. 3 is a perspective view illustrating a filling part 30;

FIG. 4 is a cross-sectional view illustrating the filling part 30;

FIG. 5 illustrates a flow of a secondary battery production method S10;

FIG. 6 illustrates a sealing step S14; and

FIG. 7 illustrates an example of nonjoint areas.

### DESCRIPTION OF EMBODIMENTS

### 1. Structure of Secondary Battery

First, structure of a secondary battery 10 according to one example of the present disclosure will be described with reference to the drawings. The directions indicated by a three-dimensional orthogonal coordinate system are also shown in the drawings. Here, the x-y plane shall be the horizontal plane, the direction indicated by the z-axis shall be the vertical direction, and a part at a larger coordinate in the x-axis shall be at an upper position.

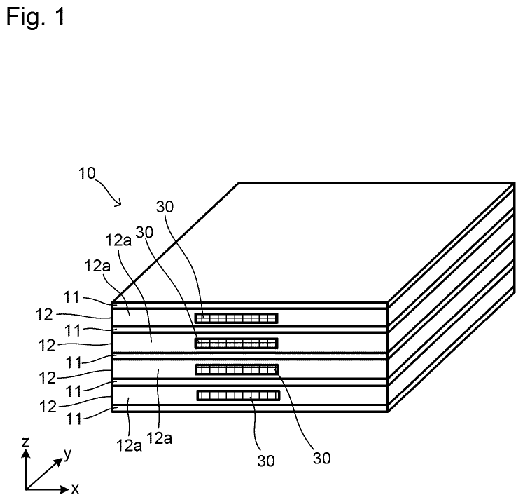

FIG. 1 is a schematic external perspective view illustrating the structure of the secondary battery 10. In this embodiment, the secondary battery 10 is a bipolar-type lithium ion secondary battery. As shown, the secondary battery 10 has a plurality of metal conductive plates 11, and a plurality of electricity storage modules 12. Series connection is established by alternately stacking and electrically connecting these plates and modules to each other. The secondary battery 10 is typically used as a battery for hybrid electric vehicles and battery electric vehicles.

Both the ends of this stacking in the stacking direction (direction indicated by the z-axis in FIG. 1) are conductive plates 11. A cathode terminal (not shown) is connected to a conductive plate 11 that is at an end in the stacking direction on one side, and an anode terminal (not shown) is connected to a conductive plate 11 that is at an end in the stacking direction on the other side.

The electricity storage modules 12 are each a single cell in the form of a flat plate as a whole, and each have front and back surfaces, and a side surface 12a which forms a thickness thereof.

### 1.1. Internal Structure of Storage Module

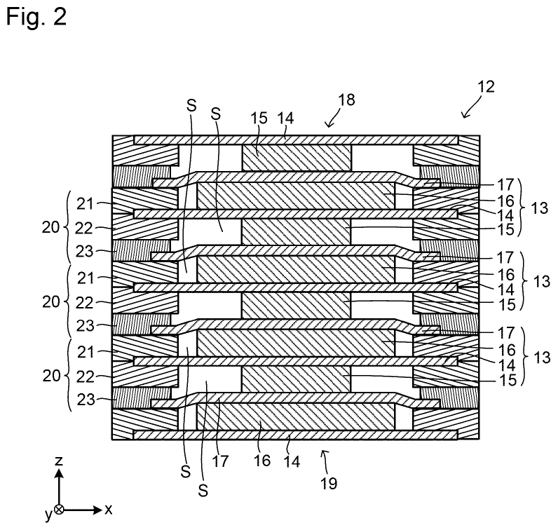

FIG. 2 focuses on one of the electricity storage modules 12 to schematically show the internal structure of this electricity storage module 12 cross-sectional view.

The electricity storage module 12 is provided with an electrode stack formed by stacking a plurality of bipolar electrodes 13, a plurality of sealing bodies 20 included in the respective bipolar electrodes 13, and a filling part 30 (see FIG. 1) that is a portion via which an electrolytic solution is injected. A plurality of the bipolar electrodes 13 are stacked in the thickness direction (direction indicated by the z-axis, or thickness direction for a flat plate form). The sealing bodies 20 are disposed around the respective bipolar electrodes 13.

### 1.1.1. Electrode Stack

### [Bipolar Electrode]

In the following description of each member, the terms “upper face” and “lower face” may be used. In FIG. 2, the “upper face” means a face at a larger coordinate in the z-axis, and the “lower face” means a face at a smaller coordinate in the z-axis. Such terms are used for convenience, whereas the “upper face” can be also referred to as a “first face” instead, and the “lower face” can be also referred to as a “second face” instead.

The bipolar electrodes 13 each include a current collector foil 14, a cathode active material layer 15 (first active material layer) provided on the lower face of the current collector foil 14, an anode active material layer 16 (second active material layer) provided on the upper face of the current collector foil 14, and a separator 17.

The current collector foil 14 is an electroconductive member in the form of foil. For example, a metal foil is used as the current collector foil 14. This metal foil is not necessarily a single layer, but may be a clad foil or laminated foil that is formed of laminated different metal foils. Metals as used herein are not particularly limited. For example, a foil formed by laminating an aluminum foil and a copper foil in such a way that the upper face is an aluminum layer and the lower face is a copper layer is used. Other examples of metals as used herein include titanium, nickel, stainless steels (e.g., SUS304, SUS316 and SUS301 specified by JIS G 4305:2015), and steels (e.g., cold-reduced carbon steel sheet (such as SPCC) specified by JIS G 3141:2005).

The cathode active material layer 15 constitutes a cathode of the bipolar electrode 13, and in this embodiment, is arranged on the lower face of the current collector foil 14 via an adhesive layer of acetylene black or the like.

The cathode active material layer 15 may contain a cathode active material, a conductive aid, and a binder.

Examples of a cathode active material as used herein include complex oxides, metallic lithium, and sulfur. For example, the composition of a complex oxide as used herein includes lithium, and at least one of iron, manganese, titanium, nickel, cobalt, and aluminum. Examples of a complex oxide as used herein include olivinic lithium iron phosphate (LiFePO₄), LiCoO₂, and LiNiMnCoO₂.

A binder as used herein plays a role in securing the active material or a conductive aid to the surface of the current collector foil 14 to maintain a conducting network in the electrode. Examples of the binder include: fluorine-containing resins such as polyvinylidene fluoride, polytetrafluoroethylene, and fluorocarbon rubber; thermoplastic resins such as polypropylene and polyethylene; imide resins such as polyimide and polyamideimide; alkoxysilyl group-containing resins; acrylic resins having a monomer unit such as acrylic acid and methacrylic acid; styrene-butadiene rubber (SBR); carboxymethyl cellulose; alginates such as sodium alginate and ammonium alginate; water-soluble cellulose ester crosslinked products; and starch-acrylic acid graft polymers. One or a plurality of these binders may be used.

Examples of a conductive aid as used herein include acetylene black, carbon black, and graphite.

The anode active material layer 16 constitutes an anode of the bipolar electrode 13, and in this embodiment, is arranged on the upper face of the current collector foil 14.

The anode active material layer 16 may contain an anode active material, a conductive aid, and a binder. A conductive aid and a binder as used herein can be considered in the same way as those for the cathode active material layer 15.

Examples of an anode active material as used herein include: carbons such as graphite, artificial graphite, highly oriented graphite, mesocarbon microbeads, hard carbon, and soft carbon; metallic compounds; elements that can form alloys with lithium, and compounds thereof; and boron-doped carbon. Examples of elements that can form alloys with lithium as used herein include silicon and tin.

The separator 17 is, for example, a porous sheet containing a polymer that absorbs and holds a liquid electrolyte, or a nonwoven fabric; and in this embodiment, is arranged on the upper face of the anode active material layer 16.

Examples of the material constituting the separator 17 include polypropylene, polyethylene, polyolefin, and polyester. The separator 17 may have a single-layer structure, or may have a multilayer structure.

An example of an electrolyte absorbed and held by the separator 17 is a liquid electrolyte (electrolytic solution) containing a nonaqueous solvent, and an electrolyte salt dissolving in the nonaqueous solvent. When the separator 17 is impregnated with the electrolyte, a known lithium salt such as LiClO₄, LiAsF₆, LiPF₆, LiBF₄, LiCF3SO₃, LiN(FSO₂)₂, and LiN(CF₃SO₂)₂ can be used as the electrolyte salt. As the nonaqueous solvent, a known solvent such as cyclic carbonates, cyclic esters, chain carbonates, chain esters, and ethers can be used.

The current collector foil 14, the cathode active material layer 15, the anode active material layer 16, and the separator 17 are formed so as to have different sizes in a plan view. More specifically, the current collector foil 14 is the largest, the separator 17 is the second largest, the anode active material layer 16 is the second smallest, and the cathode active material layer 15 is the smallest. As can be seen from FIG. 2, the centers of the current collector foil 14, the cathode active material layer 15, the anode active material layer 16, and the separator 17 are arranged at the same position in a plan view, and the difference therebetween in size lies in the degrees of the protrusions (overhangs) of the edges. Therefore, the edge of the current collector foil 14 protrudes most. The edge of the separator 17 protrudes second most, the edge of the anode active material layer 16 protrudes second least, and the edge of the cathode active material layer 15 protrudes least in such a way that these edges are inside the edge of the current collector foil 14.

For forming the cathode active material layer 15 and the anode active material layer 16 on the current collector foil 14, for example, a conventionally known method such as roll coating, die coating, dip coating, a doctor blade method, spray coating, and curtain coating is used. Specifically, the active material and a solvent, and the binder and the conductive aid if necessary are mixed to produce a slurry composition for forming the active material layer. This composition for forming the active material layer is applied on the upper face and the lower face of the current collector foil 14, and dried. Examples of a solvent as used herein include N-methyl-2-pyrrolidone, methanol, methyl isobutyl ketone, and water.

### [Stacking Structure of Electrode Stack]

In the electrode stack, any adjacent bipolar electrodes 13 in the stacking direction (direction indicated by the z-axis) are stacked, so that the cathode active material layer 15 of one of the adjacent bipolar electrodes 13 and the separator 17 of the other one thereof are laid on each other.

In addition, the electrode stack has a cathode terminating electrode 18 on an upper end thereof in the stacking direction of the stack formed of the bipolar electrodes 13, and an anode terminating electrode 19 lower end thereof in the stacking direction thereof.

The cathode terminating electrode 18 has a current collector foil 14, and a cathode active material layer 15 provided on the lower face of the current collector foil 14. The cathode active material layer 15 is stacked bipolar electrode 13 adjacent thereto, and the current collector foil 14 is stacked on the upper face thereof.

The anode terminating electrode 19 has a current collector foil 14, an anode active material layer 16 provided on the upper face of the current collector foil 14, and a separator 17 stacked on the upper face of the anode active material layer 16. The separator 17 is stacked bipolar electrode 13 adjacent thereto, the anode active material layer 16 is stacked on the lower face of the separator 17, and the current collector foil 14 is further stacked on the lower face of the anode active material layer 16.

The cathode terminating electrode 18 and the anode terminating electrode 19 are stacked on respective conductive plates 11 that are adjacent to the current collector foils 14 thereof.

### 1.1.2. Sealing Body

The sealing bodies 20 are the members arranged along the circumferential ends of the bipolar electrodes 13, thereby sealing the bipolar electrodes 13. According to this, the gaps between any bipolar electrodes 13 that are adjacent in the stacking direction are also sealed. In this embodiment, the sealing bodies 20 each have a first sealing member 21, a second sealing member 22, and a spacer 23.

### [First Sealing Member]

The first sealing member 21 is a frame-shaped member, and is arranged along the circumferential end (outer edge) of each of the bipolar electrodes 13. Specifically, as can be seen from FIG. 2, the first sealing member 21 is arranged between and joined to the upper face of the current collector foil 14 and the lower face of the separator 17 along the circumferential end of the bipolar electrode 13 whereby the anode active material layer 16 is arranged in the frame.

In this embodiment, a predetermined space is provided between the inner edge of the first sealing member 21, and the anode active material layer 16 to form a space S. On the contrary, the outer edge of the first sealing member 21 is configured, so that the first sealing member 21 protrudes more outwards than the current collector foil 14.

The first sealing member 21 has electrical insulation properties, and can be made from a known resin material having electrolyte tolerance, such as acid-modified polyethylene (acid-modified PE), acid-modified polypropylene (acid-modified PP), polyethylene, and polypropylene.

### [Second Sealing Member]

The second sealing member 22 is a frame-shaped member, and is arranged along the circumferential end (outer edge) of each of the bipolar electrodes 13. Specifically, as can be seen from FIG. 2, the second sealing member 22 is arranged between and joined to the lower face of the current collector foil 14 and the upper face of the spacer 23 along the circumferential end of the bipolar electrode 13, and the cathode active material layer 15 is arranged in the frame in combination with the spacer 23.

In this embodiment, a predetermined space is provided between the inner edge of the second sealing member 22, and the cathode active material layer 15 to form a space S. On the contrary, the outer edge of the second sealing member 22 is configured, so that the second sealing member 22 protrudes more outwards than the current collector foil 14. The upper face of the second sealing member 22 and the lower face of the first sealing member 21 are joined.

The material of the second sealing member 22 can be considered in the same way as that of the first sealing member 21.

### [Spacer]

The spacer 23 is a frame-shaped member, and is arranged along the circumferential end of the each of the bipolar electrodes 13. Specifically, as can be seen from FIG. 2, the spacer 23 is combined with the second sealing member 22, thereby, along the circumferential end of the bipolar electrode 13, being arranged between and joined to the lower face of the second sealing member 22 and the upper face of the separator 17 of a bipolar electrode 13 adjacent thereto, and the cathode active material layer 15 is arranged in the frame.

In this embodiment, the inner edge of the spacer 23 is located apart from the cathode active material layer 15. On the contrary, the outer edge of the spacer 23 protrudes more outwards than the separator 17, and the lower face of the spacer 23 is joined to the upper face of the first sealing member 21 of a sealing body 20 adjacent to the spacer 23.

The material of the spacer 23 can be considered in the same way as that of the first sealing member 21.

### 1.1.3. Filling Part

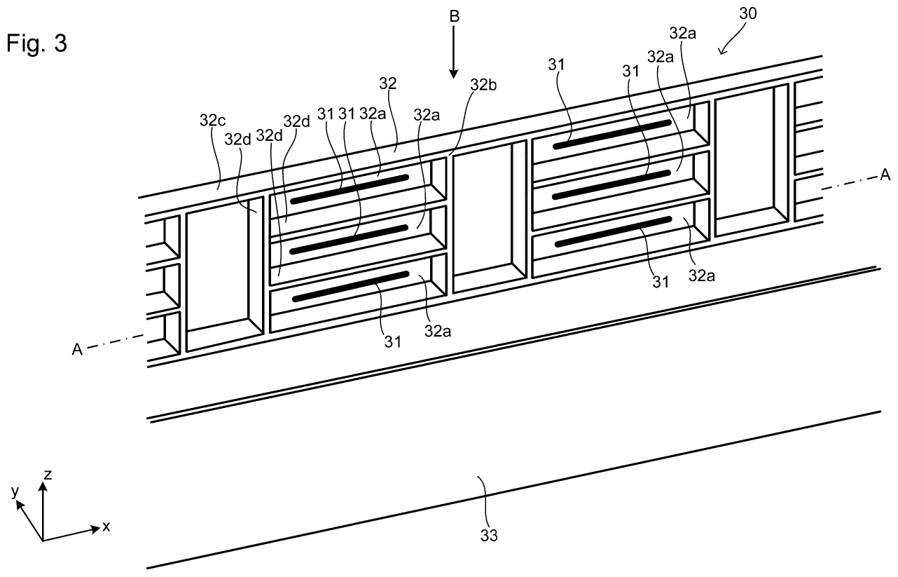

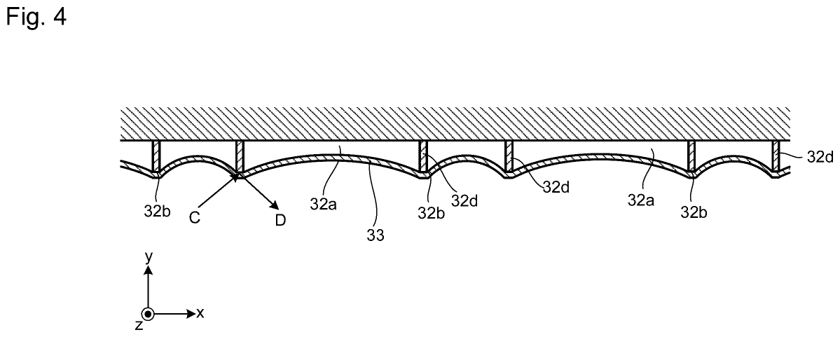

The filling part 30 is formed on part of the side surface 12a of each of the electricity storage modules 12, and is a portion for injecting the electrolytic solution into the inside of the electricity storage module 12 (filling the inside of the electricity storage module 12 with the electrolytic solution). FIG. 3 focuses on one of the electricity storage modules 12 of FIG. 1 to partially show a portion of the side surface 12a of the one electricity storage module 12 where the filling part 30 is arranged in an enlarged exploded perspective view (where a resin film 33 is separately shown). FIG. 4 is a cross-sectional view taken along the line A-A of FIG. 3, which is parallel to the x-axis (where the resin film 33 is not separated).

In this embodiment, the filling part 30 has filling ports 31, a filling frame 32, and the resin film 33.

### [Filling Port]

The filling ports 31 are formed on the side surface 12a of the electricity storage module 12, and are each an opening that is at a hole (not shown) penetrating the sealing body 2 to allow the space S and the outside to communicate, and that is formed on the side surface 12a side. For example, one filling port 31 (through hole) can be provided on one bipolar electrode 13. In this case, the filling ports 31 in number corresponding to the number of the provided bipolar electrodes 13 are formed. As described above, since being stacked, a plurality of the bipolar electrodes 13 are at different positions in the direction indicated by the z-axis in FIG. 3. Therefore, the positions of the filling ports 31 in the direction indicated by the z-axis also differ correspondingly to the positions of the bipolar electrodes 13.

In this embodiment, the filling ports 31 (through holes) are each a horizontally long slit having longer sides extending in the circumferential direction of the side surface 12a. This shape is not particularly limited, whereas the filling port 31 (through hole) in the form of slit allows the electrolytic solution to be efficiently injected because, due to characteristics of the space S, the shape of the space S communicating to the filling port 31 (through hole) is small in the stacking direction of the bipolar electrode 13 (direction indicated by the z-axis in FIG. 3), and is large in the plane direction (the direction indicated by the x-y plane in FIG. 3).

### [Filling Frame]

The filling frame 32 is a tubular member, and is arranged on the side surface 12a. The filling frame 32 is arranged so as to surround every filling port 31 whereby recesses 32a each having an opening surrounded by the filling frame 32 are formed using the thickness of the filling frame 32 (size in the direction indicated by the y-axis in FIG. 3), and the side surface 12a having the filling ports 31 as bottoms. A face 32b of the filling frame 32 that is on the opposite side of a side of the filling frame 32 that is in contact with the side surface 12a serves as a welded face to the resin film 33.

In this embodiment, the filling frame 32 has a rectangular outer frame 32c that forms the outer shape thereof. The inside of the outer frame 32c is partitioned by partition walls 32d to form the recesses 32a.

The outer frame 32c is a frame body made of a rectangular tubular member along the x-z plane, and has a shape extending longer in the direction indicated by the x-axis than the direction indicated by the z-axis. The recesses 32a partitioned by the partition walls 32d each also have a shape longer in the direction indicated by the x-axis than the direction indicated by the z-axis.

The material constituting the filling frame 32 is not particularly limited, and, in some embodiments, may be formed from a resin. Among resins, in some embodiments, polyethylene is used.

### [Resin Film]

The resin film 33 is a sealing material made from a resin in the form of sheet, covers the filling frame 32 so as to cover the recesses 32a formed by the filling frame 32, and is welded to the face 32b. This can prevent the injected electrolytic solution from leaking from the secondary battery 10.

The resin film 33 is transparent. This allows the condition of the welded face of the filling frame to the resin film to be visually and accurately grasped as described later. Here, “transparent” means properties of a condition where a light transmissivity is so high that a side across the resin film can be seen thorough the resin film. At this time, the resin film may be either colorless or colored as long as being transparent.

The resin film 33 is made from a resin, and the layer structure thereof is not particularly limited as long as being transparent. In some embodiments, the resin film 33 has a layer made from at least one of polyvinyl alcohol and polyethylene. Polyvinyl alcohol allows the permeability for the electrolytic solution to be suppressed low, which causes the resin film 33 to have high barrier properties while securing transparency. According to the test by the inventor, when the resin film made from polyvinyl alcohol was welded to the filling frame by pressing a heating body (145° C. in heating temperature, 10 seconds in pressing time, and 0.1 mm in pressing amount), the amount of the permeation of the electrolytic solution daily was 0.1 mL per 1 m². This was approximately 1/200 of the amount of the permeation of polyethylene.

On the contrary, polyethylene leads to weldability when the filling frame is made from polyethylene. In some embodiments, a resin film of a two-layer structure formed by using polyethylene as a layer that is to be on the filling frame side, and layering a layer made from polyvinyl alcohol on this polyethylene layer may be used. It is noted that the weldability (heat adhesiveness) to the filling frame (polyethylene) can be also secured by polyvinyl alcohol itself, and the resin film 33 may be formed of a single layer of polyvinyl alcohol.

The resin film 33 is formed from a resin material only, and therefore, has high flexibility. Therefore, as can be seen from FIG. 4, the resin film 33 is concave at the centers of the recesses 32a after sealing (because of vacuuming in electrolytic solution filling as described later). Therefore, the volume (capacity) of the recesses 32a sealed by the resin film 33 can be reduced, and an excess electrolytic solution gathered there can be reduced or the amount of the electrolytic solution that should be actually in the bipolar electrodes 13 but is gathered in the recesses 32a can be reduced.

### 2. Secondary Battery Production Method

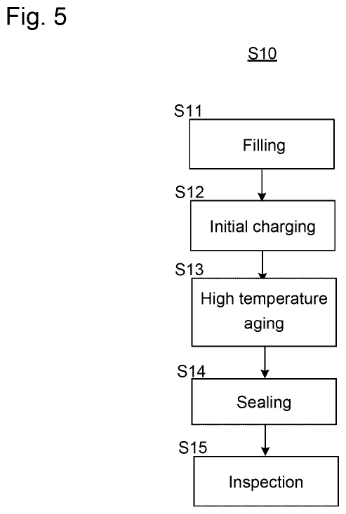

For example, the secondary battery 10 can be produced by a production method S10 as the flow shown in FIG. 5. As can be seen from FIG. 5, the secondary battery production method S10 includes a filling step S11, an initial charging step S12, a high temperature aging step S13, a sealing step S14, and an inspection step S15 that will be described in more detail below.

### 2.1. Filling Step

In the filling step S11, the electrolytic solution is injected into the bipolar electrodes 13. For example, in the filling step S11, the secondary battery 10 before the electrolytic solution is injected (the resin film 33 have not been welded yet) is put in a chamber, and an electrolytic solution feeding apparatus is connected to the filling frame 32. The insides of the bipolar electrodes 13 are vacuumed with a vacuum pump via a vacuum tube by opening a valve arranged at the electrolytic solution feeding apparatus. The valve is closed, and the inside of the chamber is kept in a pressure-reduced state. In this state, a valve of an electrolytic solution supply pipe is opened, and the electrolytic solution is fed to the bipolar electrodes 13 via the recesses 32a and the filling ports 31 through the through holes, and injected to the insides of the bipolar electrodes 13.

### 2.2. Initial Charging Step

In the initial charging step S12, the initial charging is performed. The conditions for the initial charging step are not particularly limited, but are as known.

### 2.3. High Temperature Aging Step

Next, the high temperature aging step S13 is performed. The step of high temperature aging is as known, whereas, for example, a break-in operation is done under the procedures as the secondary battery 10 is allowed to stand still at 65° C. for 15 hours.

### 2.4. Sealing Step

In the sealing step S14, the filling frame 32 is covered with the resin film 33, so that the resin film 33 covers the recesses 32a formed by the filling frame 32, and the resin film 33 is welded to the face 32b of the filling frame 32, which is more specifically as follows.

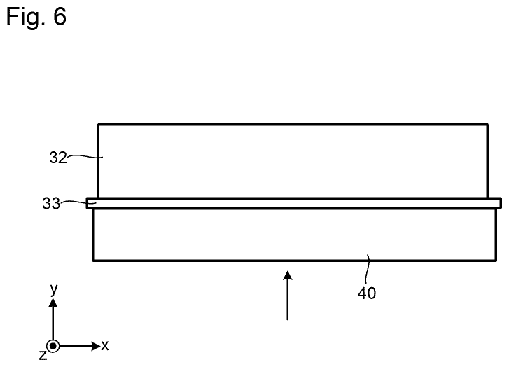

FIG. 6 schematically shows a sealing method according to one example of the mode in the sealing step S14. In FIG. 6, the filling frame 32 and the resin film 33 are shown in the direction indicated by the arrow B of FIG. 3 (i.e., from the above).

As can be seen from FIG. 6, in the sealing step S14 in this example, a heat generating body 40 is pressed against the resin film 33 covering the filling frame 32 (pressed in the direction indicated by the y-axis) to weld the filling frame 32 and the resin film 33 on the portion sandwiched between the filling frame 32 and the heat generating body 40. Specific welding conditions are not particularly limited. The temperature, the pressing time, and the pressing amount of the heat generating body 40 may be set if necessary.

The welding method in this example is capable of suppressing welding costs low.

The sealing step according to another example of the mode includes to use a laser. More specifically, after the resin film 33 is brought into contact with the filling frame 32, the interface between the resin film 33 and the filling frame 32 is melted and adhered by laser irradiation from the resin film 33 side along the filling frame 32. A laser as used herein is not particularly limited. An example of such a laser is a laser having a wavelength that the filling frame and the resin film can absorb.

The welding method in this example is capable of suppressing heating of the resin film other than the welded portion to suppress damage to the resin film less.

### 2.5. Inspection Step

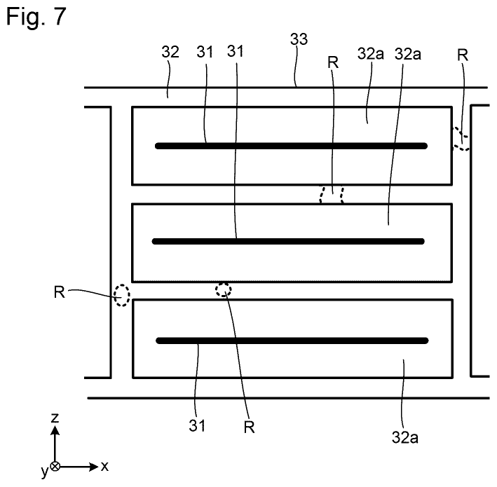

In the inspection step S15, the welding condition of the welded portion of the filling frame 32 and the resin film 33 obtained in the sealing step S14 is inspected, and the presence or not of an unwelded area is detected. In the welded condition to be inspected here, an unwelded area (which may be referred to as a “nonjoint area”) is detected at least in the portion where the filling frame 32 and the resin film 33 should be welded. A nonjoint area here is a portion in the condition where air bubbles are present therein, or an unwelded portion having an area larger than air bubbles. FIG. 7 shows an example of nonjoint areas R by dotted lines.

The presence of such a nonjoint area raises the probability that electrolytic solutions in different cells are mixed as described above, which may cause short circuits, and can cause heat generation and/or ignition. Then, in the inspection step S15, such a nonjoint area exceeding a predetermined degree is detected and excluded, and the problem is solved by, for example, carrying out the sealing step S14 again. A predetermined degree here may be determined on the basis of threshold values of the total area of the nonjoint area, the number of the nonjoint areas, and the maximum area of one nonjoint area that are predetermined by a preliminary test or the like.

In the present disclosure, the transparent resin film 33 is used as a sealing material. Therefore, the joined face can be visually recognized via the transparent film 33 after the sealing step S14. Thus, the nonjoint area can be easily detected.

Specific examples of the method of recognizing the nonjoint area include the method by visual observation, and the method of identifying the nonjoint area by processing an image obtained by photographing the resin film welded to the tubular member (filling frame).

An example of the method of obtaining the image for image processing is photographing with a camera. In this case, one may irradiate the resin film with a polarized light as illumination to let a reflected light of the polarized light pass through a polarizing lens, and image a desired phase with a camera. More specifically, an image obtained by letting components of a reflected light D other than the regular reflection component pass through a polarizing lens is photographed with a camera: the reflected light D is a component of a polarized light that does not reflect on the surface of the transparent film 33 but reaches the joined face as indicated by the arrow C in FIG. 4, and that irregularly reflects on the joined face, so that phases thereof are changed. This enables the condition of the joined face to be clearly grasped even in a situation where the joined face is difficult to see due to regular reflection on the transparent film 33.

As described above, according to the present disclosure, the presence or not of faults in joining of a tubular member (filling frame) with a film for sealing, such as voids, can be easily inspected, and production of insufficiently sealed secondary batteries as products can be suppressed.

### REFERENCE SIGNS LIST

10 Secondary battery
11 conductive plate
12 electricity storage module
13 bipolar electrode
20 sealing body
30 filling part
31 filling port
32 filling frame (tubular member)
33 resin film
40 heat generating body

What is claimed is:

1. A method of producing a secondary battery that has an electrode, the method comprising:
filling the electrode with an electrolytic solution via a filling port surrounded by a tubular member;
welding a transparent resin film to the tubular member, and sealing an opening of the tubular member; and
inspecting a welded condition of the tubular member and the resin film, and detecting presence or not of an unwelded area by a method by visual observation, or by a method of identifying a nonjoint portion by processing an image obtained by photographing the resin film welded to the tubular member.

2. The method of producing a secondary battery according to claim 1, wherein
the tubular member contains polyethylene, and the resin film has a polyethylene layer.

3. The method of producing a secondary battery according to claim 2, wherein
the resin film has a polyvinyl alcohol layer, and the polyethylene layer is side of the tubular member.

4. The method of producing a secondary battery according to claim 1, wherein
in the welding and sealing, the resin film is welded to the tubular member by pressing a heating body against the resin film.

5. The method of producing a secondary battery according to claim 1, wherein
in the welding and sealing, the welding is performed by irradiation with a laser from a side of the resin film along the tubular member after the resin film is brought into contact with the tubular member, the laser having a wavelength that the tubular member and the resin film can absorb.

6. The method of producing a secondary battery according to claim 1, wherein
in the inspecting and detecting, the detecting is performed by irradiating a welded face of the tubular member to the resin film with a polarized light, and receiving a reflected light of the polarized light.

7. A secondary battery comprising:
a filling port for injecting an electrolytic solution into an electrode;
a tubular member formed so as to surround the filling port; and
a transparent resin film covering an opening of the tubular member.

8. The secondary battery according to claim 7, wherein
the tubular member contains polyethylene, and the resin film has a polyethylene layer.

9. The secondary battery according to claim 7, wherein
the resin film has a polyvinyl alcohol layer, and the polyethylene layer is side of the tubular member.
